(19) United States
(12) Patent Application Publication
(10) Pub. No.: US 2013/0018499 A1
(43) Pub. Date: Jan. 17, 2013

(54) PRODUCIBILITY ANALYSIS DURING ENGINEERING DESIGN OF COMPOSITE PARTS

(71) Applicants: Jeffrey L. Miller, Mukilteo, WA (US); Stephen J. Dostert, Edmonds, WA (US)

(72) Inventors: Jeffrey L. Miller, Mukilteo, WA (US); Stephen J. Dostert, Edmonds, WA (US)

(73) Assignee: THE BOEING COMPANY, Chicago, IL (US)

(21) Appl. No.: 13/267,878

(22) Filed: Oct. 6, 2011

Related U.S. Application Data
(60) Provisional application No. 61/507,115, filed on Jul. 12, 2011.

(51) Int. Cl. G06F 19/00

(52) U.S. Cl. 700/103

(57) ABSTRACT

A method comprises using a computer to access an engineering definition of a composite part and apply a set of rules governing material laydown prior to performing the laydown.

This application claims the benefit of provisional application 61/507,115 filed Jul. 12, 2011.

### BACKGROUND

Commercial aircraft may be damaged by bird strikes, ground handling equipment, debris, hail and other unplanned events. Those events can create holes and tears in aircraft skin, and damage to underlying stiffening substructure (e.g., frames, stiffeners and pad-ups). For instance, an aircraft's nose cab section may be damaged by a bird strike, a lower lobe may be damaged due to nose gear collapse, mid-section door surrounds may be damaged due to collisions with ground handling equipment, an end section lower lobe may be damaged by a tail strike, etc.

It is important to repair a damaged aircraft and return it to service as quickly as possible. Down time is very costly to an aircraft carrier, as an idle aircraft results in lost revenue.

Repair of a panelized aluminum aircraft is relatively straightforward. A damaged panel and underlying substructure are removed from the aircraft and replaced. If panels are available, the repair can be implemented relatively quickly.

Repair of composite commercial aircraft is not so straightforward, especially for large area repairs of one-piece components. Consider a fuselage made up of several one-piece composite barrel sections. Each barrel section includes skin, hoop frames, and stiffeners (e.g., stringers). The stiffeners may be integrated with the skin (by co-curing during fabrication). The hoop frames may be mechanically fastened to the skin. If a large area of a fuselage section becomes damaged, removing and replacing the entire barrel section would be prohibitively expensive, disruptive to production, and time consuming.

An infrastructure for large area repair of one-piece composite aircraft components is needed.

### SUMMARY

According to embodiment herein, a method comprises using a computer to access an engineering definition of a composite part and apply a set of rules governing material laydown prior to performing the laydown.

According to another embodiment herein, an apparatus comprises a computer programmed to access an engineering definition of a composite part and apply a set of rules governing material laydown prior to the laydown being performed, the rules relating to deviations and defects from laying down material at a given width.

According to another embodiment herein, an article comprises computer-readable memory programmed with data for causing a computer to access an engineering definition of a composite part, and apply a set of rules governing material laydown prior to the laydown being performed.

According to another embodiment herein, a method of fabricating a composite aircraft part comprises receiving design data for the aircraft part. The part includes aircraft skin and integrated stiffening elements. The design specifies part geometry, ply boundaries, ply drops, stacking sequence, and fiber orientations within each boundary. The method further comprises applying a set of rules governing composite laydown prior to the design prior to performing the laydown of the part.

### BRIEF DESCRIPTION OF THE DRAWINGS

FIG. 1 is an illustration of a method of creating a composite part.

FIG. 2 is an illustration of an apparatus for applying a set of rules governing material laydown to an engineering definition of the composite part.

FIG. 3 is an illustration of an aircraft including a composite fuselage.

FIG. 4 is an illustration of skin and underlying stiffening substructure of a composite barrel section of the fuselage.

FIG. 5 is an illustration of a damaged area of a one-piece fuselage barrel.

FIG. 6 is an illustration of a replacement panel that is attached to a skin panel via a bolted splice.

FIG. 7 is an illustration of a method for repairing a damaged one-piece composite component of an aircraft, including design and fabrication of a composite replacement panel.

### DETAILED DESCRIPTION

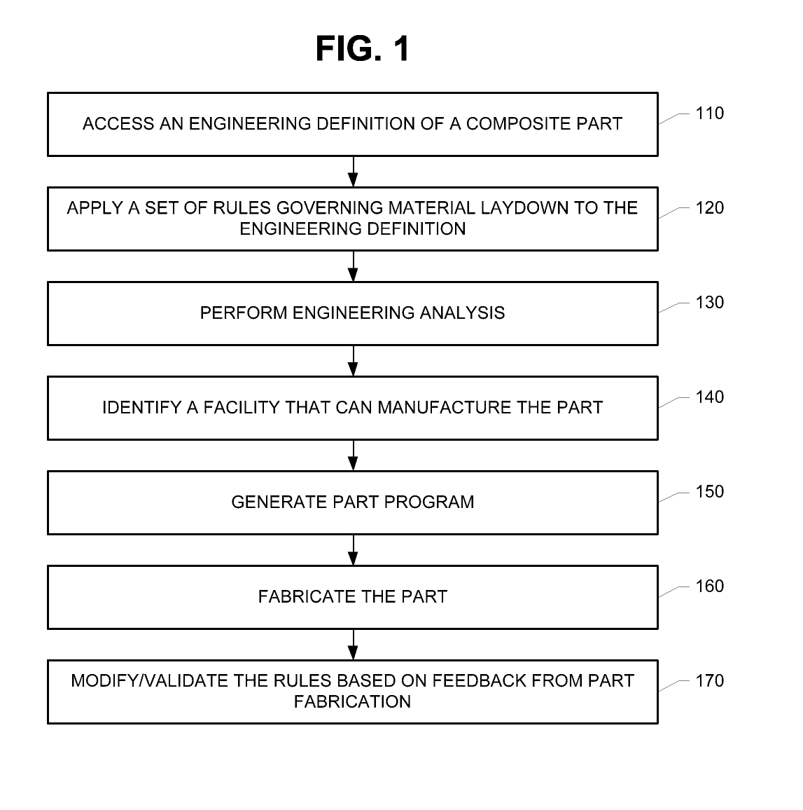

Reference is made to FIG. 1, which illustrates a method of creating a composite part including layers or plies of reinforcing fibers embedded in a matrix. One example of a composite is carbon fiber reinforced plastic (CFRP), where the constituents may include carbon fibers embedded in an epoxy matrix.

At block 110, an engineering definition of a composite part is accessed. The engineering definition may define surface geometry including contour and features such as holes, trim locations, and engineering edge of part. The engineering definition may also specify ply drops, ply boundaries stacking sequence and fiber orientations within each ply. The fiber orientations may be specified according to a rosette, which is a reference system for fiber orientation.

The engineering definition may define material specifications for the composite part. The material specifications may specify properties of the composite, including properties of the reinforcing fibers and the matrix.

The engineering definition may also define process specifications for the composite part. These process specifications may include layup instructions, processing instructions, cure instructions, processor qualifications, and inspection instructions. Process specifications may also describe allowable deviations during laydown (e.g., laps, gaps, and angular deviation from the rosette) and allowable defects in the layup (e.g., wrinkles and puckers).

At block 120, a set of rules governing material laydown is applied to the engineering definition prior to performing the laydown. The rules identify deviations and defects that will result if material of a given width is laid down in a specified direction and position. Laminates from different width materials have different mechanical performance. Different types of laminates may also have different mechanical performance.

These rules include algorithms that determine tape path for each layer of tape (a tape path includes a series of coordinate positions that determine the movement of a tool (e.g., a fiber placement head) during a machining operation). The algorithms include path generation algorithms that determine minimum steering radius for each different tape width. The algorithms further include, but are not limited to rosette algorithms that specify a rosette (direction); and natural path (which may be characterized as the path that produces a state of neutral fiber tension, where the same distance is continuously maintained between both sides of the tape).

The rules indicate whether, based on the rosette and contour of the part, material of a given width may be laid down in the desired direction and position without defects such as wrinkles or puckers. Consider the following examples. As a first example, wider tape or slit tape will generally have a smaller minimum steering radius than narrower tape (where minimum steering radius is the smallest radius by which material can be steered material with an acceptable level of wrinkles or puckers). A rule may determine whether a wider tape violates the minimum steering radius.

As a second example, a tape path is instructed to follow a natural path A rule may determine whether the natural path violates an allowable angular deviation from the rosette. The rules may also determine whether the natural path violates maximum lap or maximum gap between tape courses.

As a third example, concavity of the geometry is determined. A rule may then determine whether a compaction roller can bridge the concavity and apply sufficient compaction.

The rules may also consider penalties associated with structural performance. For instance, a weight penalty might be incurred if a laminate needs to be thickened because of material knockdown or reduction. A further penalty may be incurred by additional plies and add weight for maintaining symmetry and balance within the composite laminate.

The rules are derived from process specifications and empirical material performance. For example, minimum steering radius may be obtained for different types (material system, weave, resin content, etc.) and width of composite material by testing on a flat plate and looking for wrinkles or puckers that are within allowable limits. The type of machine used and process parameters (e.g. tension, compaction force) for the machine may also influence the results. Laminate mechanical property performance is another example of data that can be provided from testing, such as tension and compression testing. Initially, the empirical data may be obtained from testing material coupons. Over time, additional data may be obtained from testing subcomponents, or complete assemblies.

A rule for weight penalty may be based upon a set of laminate mechanical properties established for laminates made from different tape or slit tape widths of known sizes. For example, a production baseline of a laminate made using tape width X is compared against the same laminate made using tape width Y. Mechanical properties of the laminate made from tape width Y are lower than the laminate made from tape width X. Additional plies would be added to the laminate made using tape width Y to achieve the equivalent laminate mechanical properties of the laminate made using tape width X and also to maintain balance and symmetry. A weight penalty would be incurred by these additional plies.

In some instances, the rules may raise violations to established process specifications. In other instances, the rules may identify the type and/or magnitude of deviations. The engineering design may then be accessed to determine whether the deviations would result in unacceptable violations or whether the deviations may be allowed for improved manufacturability. For example, the rules predict a wrinkle based on minimum steering radius for a particular tape width in a certain zone of a part, but that zone is non-critical, and the particular tape width will result in faster laydown. In this example, the deviation may be allowed to enable a faster laydown.

The result of applying the rules is a list of tapes (by type and width) that may be used to fabricate the composite part. In some instances, the list may indicate allowable tapes per ply or part portion. As a first example, consider a contoured or compound contoured fuselage section. For this example, the list may allow up to a 6″ wide tape for a 90 degree fiber orientation, but no more than a one-half inch tape for other fiber orientations (e.g., 0, +45 and −45 degrees).

As a second example, the list allows a ½″ wide material for all areas and all fiber orientations of a part, except for one small zone. The list allows narrower width material (W) for that small zone.

At block 130, in addition to applying the rules, engineering analysis can be performed to determine if suggested tape widths satisfy engineering requirements (static, fatigue, damage tolerance, etc.). Tape widths may be eliminated for consideration if they do not satisfy the engineering requirements.

At block 140, once a part has been designed, and allowable tape widths have been identified, a facility that can fabricate the part is identified. This function may be performed separately from the rules, or it may be integrated with the rules. Integrated rules may include machine parameters (e.g., roller compliance, number of heads that can operate together), material properties, and mechanical properties.

For instance, the rules may determine whether a laydown machine configuration can perform a layup at a specified tape width, as there are limits to course sizes due to compliance of the part surface. Consider the example of machines that have thirty two ½″ wide tows or slit tape of material and others that have sixteen ½″ tows. The compaction roller for a ½″ thirty two-tow machine is 16 inches, whereas it is 8 inches for a ½″ sixteen tow machine. For the same width tow, the greater the quantity of tows that can be simultaneously employed, the faster the laydown time, assuming constant speed. In some cases, depending on panel contour the number of tows out of the total available may be limited. For example, a machine with thirty two tows over a panel with a complex contour, may have a limit of eighteen or nineteen tows that can be effectively used because of roller compliance, and in some cases potentially less, so a ½″ (32) tow machine may provide unneeded capacity for a given panel configuration. Wider tapes will likely have more challenges in compliance, especially over complex contours. Assuming a common laydown speed, the more tows, the faster material can be laid down and the faster the panel can be fabricated.

In some instances, a part does not pass any rules. It might not be able to be constructed at any tape width. Or, there might not be a facility available to produce the part. In these instances, the design may be modified, and the functions at blocks 120 to 140 may be performed again.

At block 150, after a facility has been selected, part programs are generated. A programming and simulation solution may take the requirements from the engineering design and convert them into instructions that can be processed by a layup machine. The part programs can be post processed, simulated or directly used by a machine to fabricate a part. The programs may include instructions for fiber placement machines (e.g., path for the head, angular position, and cut and add commands for the different tows), machining, etc.

At block 160, the programs are used to fabricate the part. The layup may be automated or manual layup, wet or dry, or a combination thereof. The fabric may be deposited by an end effector that performs automated fiber placement (AFP) or automated tape layer (ATL). In other embodiments, the layup may be performed manually. If the layup is dry, resin is then infused. Caul plates may then placed on the part layup (depending on finish requirements). The part layup is then bagged and cured. Afterwards, the cured part may be machined (e.g., trimmed and drilled).

At block 170, feedback may be provided to validate or modify the rules. For instance, if wrinkles are detected during laydown, and the rules had indicated that no wrinkles were expected, the rules would be modified.

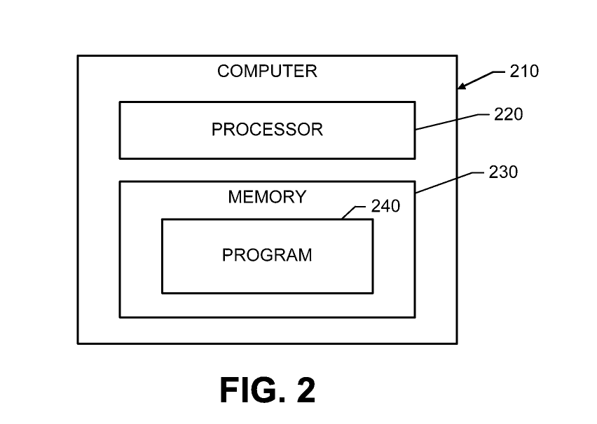

Reference is now made to FIG. 2, which illustrates a computer 210 including a processor 220, and computer-readable memory 230. A program 240 is stored in the memory 230. When executed in the computer 210, the program 240 accesses an engineering definition of a composite part and applies a set of rules governing material laydown prior to the laydown being performed.

A method and apparatus herein enables the producilbilty (or manufacturability) of the composite part to be tested before the part is actually fabricated. By considering manufacturability during the design of a part, empirical testing is minimized, thereby speeding up part production. Trial and error are avoided. Multiple iterations of redesigning, refabricating and revalidating a part are avoided. Considerable time and cost is saved from the need to physically build validation coupons and follow an iterative process of testing.

A method and apparatus herein also enable manufacturing tradeoffs to be made during the design phase. Trades may be made of potentially different tape width material, which provides flexibility in manufacturing, where the choice of automated equipment may be limited.

This reduction in time is especially valuable for designing and fabricating customized replacement panels. The customized replacement panels may be used for large area repair of composite aircraft having one-piece sections.

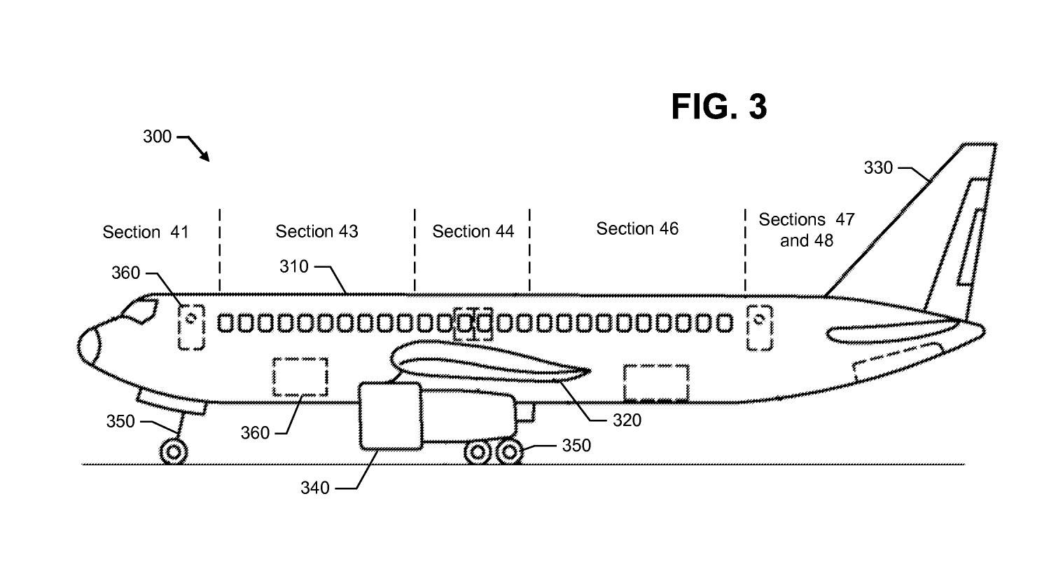

Reference is made to FIG. 3, which illustrates an example of a composite aircraft 300. The aircraft 300 generally includes a fuselage 310, wing assemblies 320, and empennage 330. One or more propulsion units 340 are coupled to the fuselage 310, wing assemblies 320 or other portions of the aircraft 300. Landing gear assemblies 350 are coupled to the fuselage 310.

In some embodiments, the entire fuselage 310 may be made of a single one-piece composite section. In other embodiments, the fuselage 310 may be formed by multiple one-piece composite sections. In the example illustrated in FIG. 3, the fuselage 310 is formed from the following one-piece composite barrel sections: a nose cab section (section 41), three mid sections (sections 43, 44 and 46), and end sections (section 47 and 48).

Passenger and cargo doors 360 are formed in all sections. Thus, all sections are susceptible to damage from ground handling equipment. All sections are also susceptible to damage from ground debris. The nose cab section is also susceptible to damage from bird strikes, which are high energy impacts. A lower lobe of the nose cab section is susceptible to damage due to nose gear collapse. A lower lobe of the end section is susceptible to damage by tail strikes.

In a large commercial aircraft, it is far more desirable to replace a damaged area than replace an entire one-piece barrel. Still, the damaged area will usually be random. That is, the location, exact size, and extent of the damage may vary from event to event. Consequently, a pre-fabricated panel might not fit well, or at all, into a damaged area. Advantageously, a customized replacement panel may be designed and fabricated quickly.

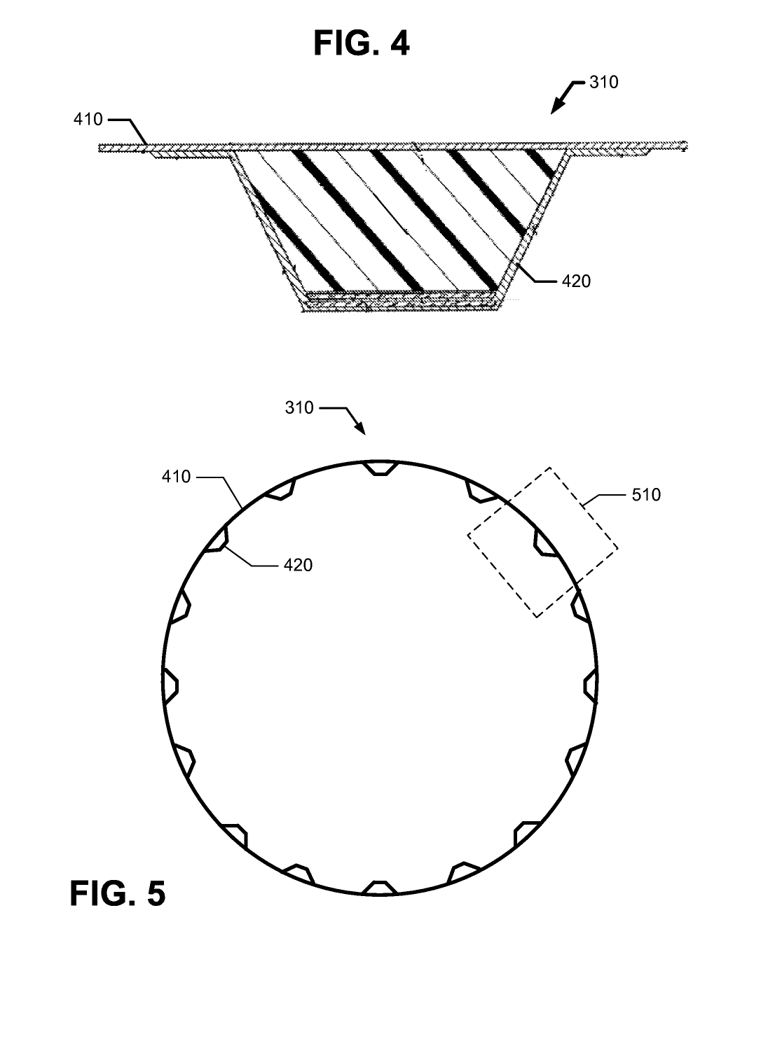

Reference is now made to FIGS. 4 and 5, which illustrate a randomly damaged area 510 of the fuselage 110. In addition to damage to the skin 410, the underlying integrated stiffening substructure 420 may also be damaged. The stiffening substructure may include longitudinally-extending stringers 420, which are co-cured with the skin 410.

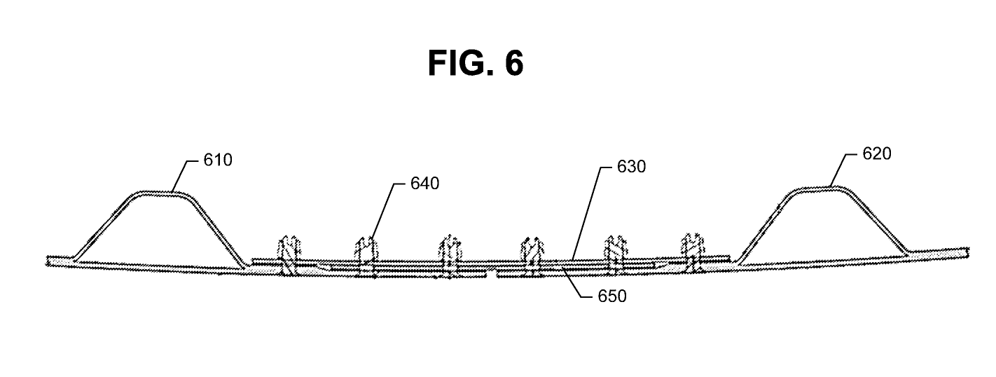

Reference is made to FIG. 6, which illustrates a replacement panel 610 that is attached to a skin panel 620 via a bolted splice. The bolted splice includes a doubler 630 that is attached to both the replacement panel 610 and the skin panel 620 by bolts 640. Non-structural filler 650 may be used to fill gaps between the doubler 630 and the replacement panel 610 or skin panel 620. The splices generally have circumferential, longitudinal, and corner configurations.

Replacement panels will vary in size. Replacement panels may range from approximately 3′×3′ to upwards of approximately 42′×20′.

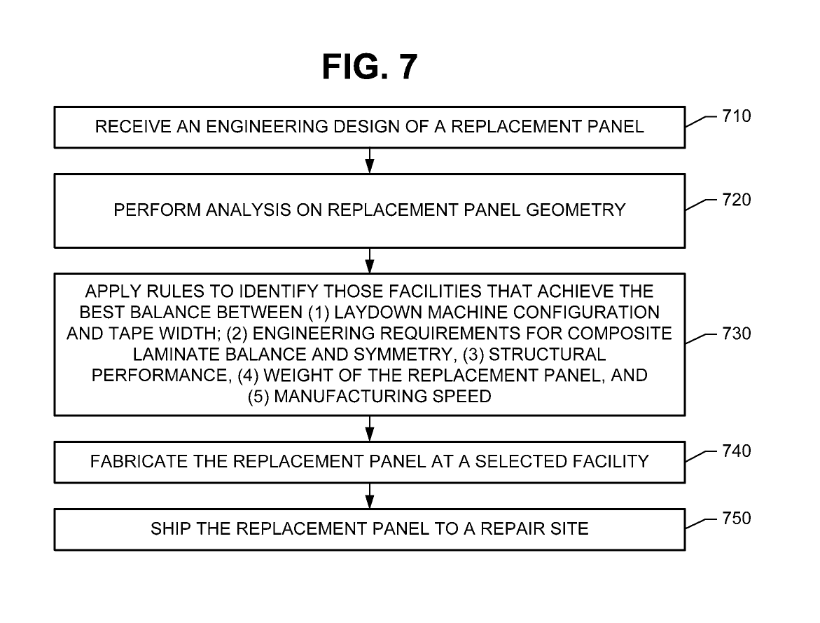

Reference is made to FIG. 7, which illustrates a method of repairing a damaged one-piece composite component of an aircraft. As used herein, the term component could refer to a major component such as a fuselage, or it could refer to a section of a major component, such as a barrel section of a fuselage.

A plurality of fabrication facilities are available to fabricate the part. These facilities have different capabilities. These capabilities include, but are not limited to, the types of layup (hand versus automated) that can be performed, the type of machines that are available, the type of end effectors that are available, and the widest available tapes that can be deposited.

At block 710, an engineering definition of a replacement panel is received. The design includes a detail panel definition for skin and integrated stiffening substructure and ply drops. This may include creating a detail panel definition based on skin and substructure that were originally used in the section, and modifying the original panel definition so the replacement panel can fit in the opening and match the contour of the component. Creating the panel definition includes creating an engineering geometry including ply boundaries, stacking sequence, fiber composition and orientations, and tape widths within each boundary.

At block 720, analysis is performed on replacement panel geometry to understand the magnitude of the contour of the panel. By understanding the magnitude and contour, choices for tape width can be narrowed. For typical automated fiber placement material, typical material widths of ⅛″, ¼″, and ½″ may be used. For hand layup and automated tape layup, wider tapes of 3″, 6″, and 12″ may be used. For hand layup, broad materials in typical widths of 36″, 48″, and up to 60″ may be used.

Some of these candidate tape widths can be eliminated at this step. For example, compound contour panels are highly unlikely candidates for hand layup (likelihoods would be based on prior producibility knowledge). Automated layup with narrower tapes (⅛″, ¼″, ½″) would only be considered. On the other hand, panels having relatively uniform surfaces might be candidates for hand layup with 6″ tape. The initial analysis reduces the overall analysis time by narrowing the type of layup (e.g., hand layup versus automated layup), candidate tape widths (e.g., ½″ tape versus ¼″ tape), candidate automated machines (e.g., machines not having capability to lay down ¼″ tape would be eliminated from further consideration), and candidate cells (e.g., cells not having capability to lay down ¼″ tape would be eliminated from further consideration).

At block 730, a set of rules is applied to the design to identify the best tape and facility for fabricating the replacement panel. The rules identify those facilities that achieve the best balance between (1) laydown machine configuration and tape width; (2) engineering requirements for composite laminate balance and symmetry, (3) structural performance, (4) weight of the replacement panel, and (5) speed of manufacturing the replacement panel (e.g. within material out time limits, machine capability, machine availability window, labor time/cost, customer need date, etc.). Other factors to be balanced may include, but are not limited to manual laydown instead of automated laydown, and engineering change effort. Engineering change effort refers to modifications from existing production configuration to incorporate different tape widths. This balance involves a trade in design change time for production time.

At block 740, the replacement panel is fabricated at the selected facility. At block 750, the replacement panel is shipped to the repair site, where it is installed in the component. The installation may include mechanically fastening the replacement panel to the component. For instance, numerous splice doublers (composite and/or titanium), fillers, and brackets may be used to fasten the replacement panel to the section. These doubler, fillers and other fastening elements may be included in the solid model design.

The method of FIG. 7 offers great flexibility in fabricating the replacement panel by considering the capabilities of different fabrication facilities. Moreover, the consideration is made while the part is being designed.

1. A method comprising using a computer to access an engineering definition of a composite part and apply a set of rules governing material laydown prior to performing the laydown.

2. The method of claim 1, wherein at least some of the rules determine allowable tape widths for layup of the part.

3. The method of claim 2, wherein the rules also determine allowable tape type for the part layup.

4. The method of claim 2, wherein the rules determine different tape widths for different plies.

5. The method of claim 2, wherein the rules determine different tape widths for different portions of the part layup.

6. The method of claim 1, wherein at least some of the rules determine penalties for structural performance as a function of a specific tape width.

7. The method of claim 1, wherein the rules are derived from empirical data as a function of tape width.

8. The method of claim 1, further comprising modifying the design to comply with any of the rules that were violated and then reapplying the rules.

9. The method of claim 1, further comprising laying down composite material after the rules have been applied.

10. The method of claim 1, wherein the engineering definition specifies a tape width, and the guidelines govern laydown at the specified tape width and greater widths.

11. The method of claim 1, wherein the material includes reinforcing fibers that will be embedded in a matrix.

12. The method of claim 1, wherein the part is an aircraft part including aircraft skin and integrated stiffening elements; and wherein the design specifies part geometry, ply boundaries, ply drops, stacking sequence, and fiber orientations within each ply.

13. An apparatus comprising a computer programmed to access an engineering definition design of a composite part and apply a set of rules governing material laydown prior to the laydown being performed, the rules relating to deviations and defects from laying down material at a given width.

14. The apparatus of claim 13, wherein the computer is further programmed to generate commands for causing a machine to perform the laydown.

15. An article comprising computer-readable memory programmed with data for causing a computer to access an engineering definition of a composite part, and apply a set of rules governing material laydown prior to the laydown being performed.

16. A method of fabricating a composite aircraft part, the method comprising:
receiving design data for the aircraft part, the part including aircraft skin and integrated stiffening elements, the design specifying part geometry, ply boundaries, ply drops, stacking sequence, and fiber orientations within each boundary; and
applying a set of rules governing composite laydown prior to performing the laydown of the part.

17. The method of claim 16, wherein applying the rules includes applying a set of producibility guidelines for tape lamination compliance over a set of different tape widths.

18. The method of claim 16, wherein a plurality of facilities having different manufacturing capabilities are available to fabricate the part; and wherein the method further comprises identifying those fabrication facilities that are best able to fabricate the part.

19. The method of claim 18, wherein the identifying includes identifying those fabrication facilities cells that achieve the best balance between (1) laydown machine configuration and tape width; (2) engineering requirements for composite laminate balance and symmetry, (3) structural performance, (4) weight of the part; and (5) speed of manufacturing the part.

20. The method of claim 16, wherein the composite part includes a replacement panel for a damaged section of a one-piece composite fuselage barrel.
